(19) United States
(12) Patent Application Publication
(10) Pub. No.: US 2004/0086772 A1
(43) Pub. Date: May 6, 2004

(54) Fuel cell electrode comprising CO and sulfur tolerant metal compound hydrogen activation catalyst

(75) Inventors: Russell R. Chianelli, El Paso, TX (US); Allan Jacobson, Houston, TX (US)

Correspondence Address: FULBRIGHT & JAWORSKI L.L.P., A REGISTERED LIMITED LIABILITY PARTNERSHIP, SUITE 2400, 600 CONGRESS AVENUE, AUSTIN, TX, 78701-3271, US

(73) Assignees: Board of Regents, The University of Texas System; The University of Houston

(21) Appl. No.: 10/654,860

(22) Filed: Sep. 4, 2003

Related U.S. Application Data
(60) Provisional application No. 60/408,779, filed on Sep. 6, 2002.

(51) Int. Cl. H01M 4/90; H01M 4/96; H01M 8/10; H01M 8/18

(52) U.S. Cl. 429/40; 429/44; 429/42; 429/30; 429/21

(57) ABSTRACT

The present invention relates to a novel hydrogen activation catalysts based on a metal compound. More particularly, this invention describes a catalyst that is poison tolerant and has a high resistance to poisoning by carbon monoxide or sulfur containing species that can be used in fuel cells including a proton exchange membrane (PEM) fuel cell.

This application claims benefit of priority to U.S. Provisional Serial No. 60/408,779, filed Sep. 6, 2002, the entire contents of which are hereby incorporated by reference.

The U.S. Government owns rights in the application pursuant to funding from the Materials Corridor Initiative Grant through grant number DE-FC04-01AL67097.

### BACKGROUND OF THE INVENTION

I. Field of the Invention

The present invention relates to a novel hydrogen activation catalysts based on a metal compound. More particularly, this invention describes a catalyst that is poison tolerant and has a high resistance to poisoning by carbon monoxide or sulfur containing species that can be used in fuel cells including a proton exchange membrane (PEM) fuel cell.

II. Description of Related Art

Fuel cells directly convert chemical energy of the reactants to a low-voltage direct current through an electrochemical reaction. The fuel cell comprises an electrode (anode), where the fuel is reduced, and an oxidant electrode (cathode) separated by an ion-conducting electrolyte. A catalyst is used at the anode and is also be used at the cathode. Unlike conventional batteries, a fuel cell does not consume the electrode material and can last as long as the fuel cell has a source of fuel, oxidant, and active catalyst and the reaction products are removed. Over time, the catalyst can lose activity due to degradation or to poisoning by impurities in the fuel such as carbon monoxide and sulfur. One of highest costs associated with producing fuel cells is obtaining an efficient catalyst that will remain active.

A particularly useful fuel cell, the proton exchange membrane fuel cell (PEM FC) is a potentially clean energy source that can replace fossil fuels due to the high current density and energy conversion capabilities inherent to PEM fuel cells. PEM fuel cells work with a polymer electrolyte in the form of a thin, permeable sheet. The electrolyte allows protons to pass through but prohibits the passage of electrons and heavier gases. PEM fuel cells have several advantages in that they can be operated at room temperature, and can be miniaturized and hermetically fabricated. The use of fuel cells in such diverse fields as pollution-free automobile industry, mobile communications equipment, medical devices, power sources for buildings, home-use power generation systems, military equipments, aerospace equipments, and rechargeable batteries underline the growing importance of PEM fuel cell use in these developing commercial markets. Currently, the DOE considers proton exchange membrane (PEM) fuel cells to be the primary candidate as the power source for electric vehicles since they possess the favorable characteristics of low temperature operation capabilities (about 175° F. or 80° C.), a quick start up time, and a high power density output that can be varied quickly to meet shifting power demands. These attribute are also favorable for application to power sources for buildings and rechargeable batteries. A PEM fuel cell (PEM FC) can be produced in a number of different ways (U.S. Pat. Nos. 6,117,581; 6,007,934; 6,344,428; 6,156,449; Hooger, 2002; Larminie, 2000).

Currently PEM fuel cells suffer from a high production cost as well as intense maintenance and repair costs. Some of the high cost is associated with the lost of catalytic activity due to poisoning of the catalyst by sulfur or CO contamination in the hydrogen fuel source during operation of the fuel cell (U.S. Pat. No. 6,007,934).

A number of methods have been developed to reduce catalyst poisoning at the anode. For example, air or oxygen is injected into the hydrogen-containing fuel stream. This oxidizes the CO to CO₂ and reduces the levels of CO in the fuel stream (Gottesfeld et al., 1988). Hydrogen purification membranes have been developed to filter impurities from the hydrogen stream before the fuel is exposed to the catalyst (U.S. Pat. No. 6,350,297). However, these membranes and oxidation procedures still allow some of the impurities through which over time will poison the catalyst.

Other methods include using metal catalysts that are more tolerant to poisons. A bimetallic electrocatalyst having both Pt and Ru was shown to have some resistance to poisoning by CO in the fuel at typical operating temperatures in a PEM fuel cell (Niedrach et al., 1967). Methanol tolerant reduction catalysts based on transition metal sulfides, for example Mo₂Ru₅S₅, have been developed and evaluated in half cell experiments (Reeve, 1998). However, poisoning of the catalyst was still significant, especially when impurities, such as sulfur, were in the fuel stream.

The use of a Pt-M alloy catalyst, where M is one or more Group IIIA or IVA metals, that is tolerant to CO in PEM fuel cells has been described in U.S. Pat. No. 5,939,220. A PEM fuel cell catalyst with high resistance to CO poisoning has been reported where Pt and Ru are supplied on a finely divided conductive support material in highly dispersed form and not alloyed with each other (U.S. Pat. No. 5,939,220).

However, there is still need for a fuel cell catalyst that is resistant to both CO and sulfur poisoning. This catalyst should be able to perform in a fuel cell without losing activity at the rate a standard catalyst loses activity in the presence of various poisons.

### SUMMARY OF THE INVENTION

Thus the present invention comtemplates an electrode comprising a catalyst that is resistant to poisoning by carbon monoxide and sulfur having the formula:

M_{Y}M′_{Y′}X_{Z}X′_{Z′};

wherein M is iron, cobalt, nickel, copper, molybdenum, ruthenium, rhodium, palladium, rhenium, osmium, iridium, platinum, or mixture thereof; M′ is molybdenum, tungsten, cobalt, nickel or mixture thereof; X is S; X′ is Se or a carbon containing compound; or ₜCₜ; with (Z+Z′)/(Y+Y′)>4/3; Y is 0.1 to 3; Y′ is 0 to 0.9; Z is 0.1 to 5; Z′ is 0 to 0.9; 0<t<1; and Y is 0.1 to 3; Y′ is 0 to 0.9; Z is 0.1 to 5; Z′ is 0 to 0.9; and a catalyst support material.

In one embodiment of the invention an electrode may comprise a catalyst as previously stated except My is ruthenium; X is S; and Z is 1.9 to 2.5.

In another embodiment of the invention an electrode may comprise a catalyst as previously stated except M_{Y} is ruthenium; M′_{Y′} is cobalt; X_{Z} is sulfur; X′_{Z}′ is C or Se; Y is 0.1 to 3; Y′ is 0 to 0.9; Z is 0.1 to 5; Z′ is 0 to 0.9.

The electrode of the current invention consist of a catalyst which may be crystalline, poorly crystalline, or amorphous in form and can be incorporated in an electrochemical device, such as a fuel cell, an electrolyser, or a sensor.

In an embodiment of the invention the electrode comprising of a catalyst is incorporated into a fuel cell, such as a proton exchange membrane fuel cell (PEM FC), a polymer-electrolyte-membrane fuel cell, a phosphoric acid fuel cell, or a regenerative fuel cell. A prefered embodiment of the invention is the incorporation of the electrode comprising of a catalyst into a proton exchange membrane fuel cell (PEM FC).

The electrode of the current invention comprises a catalyst which can be supported on a mesoporous zirconia, ceramic foam material or a carbon support material. In one embodiment of the invention the carbon support material comprises carbon black, graphite, partially graphitized carbon, acetylene black, carbon nanotubes, acetylene black, or carbon nanohoms. A prefered embodiment of the invention consist of the carbon support material comprising carbon black. In one embodiment of the invention the carbon catalyst support material further comprises a zeolite.

Yet another aspect of the current invention comprises a carbon support material comprising carbon material mixed with zeolite material or carbon particles being layered adjacent to zeolite particulate material.

Another aspect of the current invention is the electrode support material for the catalyst of the current invention can comprise of a conductive material such as a conductive particulate zeolite material, or a conductive polymer. The conductive polymer is selected from the group consisting of polyacetylene, polypyrrole, polythiophene, polyaniline and mixtures thereof. The conductive particulate zeolite material comprises continuous channels containing conductive material within the channels which can be used as an electrode support material. The conductive material can be comprised of alkali metal cations.

Another aspect of the current invention is an electrode comprising a catalyst that is resistant to poisoning by carbon monoxide and sulfur comprising RuS₂-xCx, wherein 0<x<0.5.

Yet another aspect of the current invention is an electrode comprising a catalyst that is resistant to poisoning by carbon monoxide and sulfur comprising MoS₂-xCx, wherein 0<x<1.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1—Representation of a polymer-electrolyte-membrane fuel cell (PEM FC)

FIG. 2—Electrochemical Cell Configuration

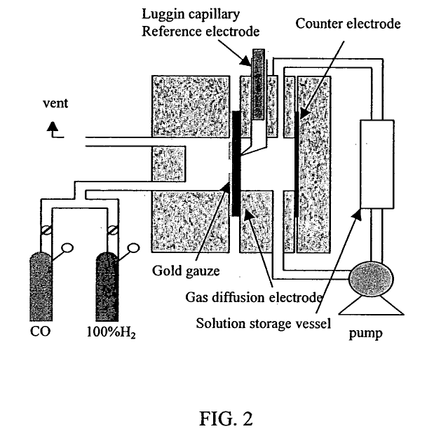

FIG. 3—The introduction of CO results in an increase in the overpotential for hydrogen evolution and a large increase in the overpotential for hydrogen oxidation for the commercial electrode tested.

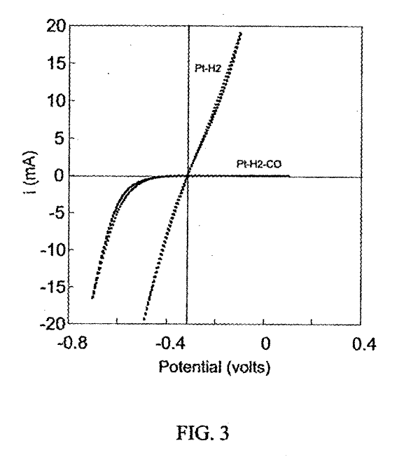

FIG. 4—The results with the RuS₂—H₂ electrode are in contrast to the Pt—H₂ electrode with a lower overall pontential for hydrogen oxidation occuring with the introduction of 1% CO.

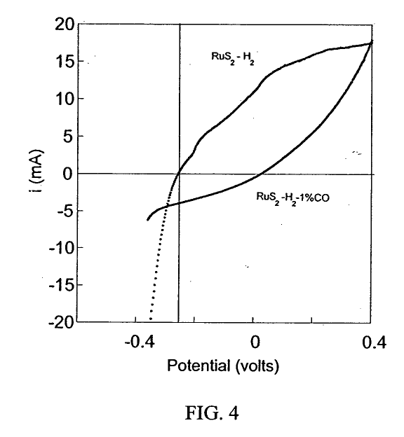

### DESCRIPTION OF ILLUSTRATIVE EMBODIMENTS

The present invention relates to a catalyst having high resistance to poisoning by carbon monoxide or sulfur containing species. This catalyst is useful, for example, at the anode of a PEM fuel cell. The general composition is M_{Y}M′_{Y′}X_{Z}X′_{Z}, where M is the active metal component and M′ is a diluent metal. X is sulfur and X′ is another suitable anion such as oxygen, sulfur, carbon, nitrogen, selenium, or mixtures thereof. The catalyst may be used unsupported or supported on a suitable porous support, and may be used in combination with a PEM fuel cell.

### I. PEM Fuel Cell

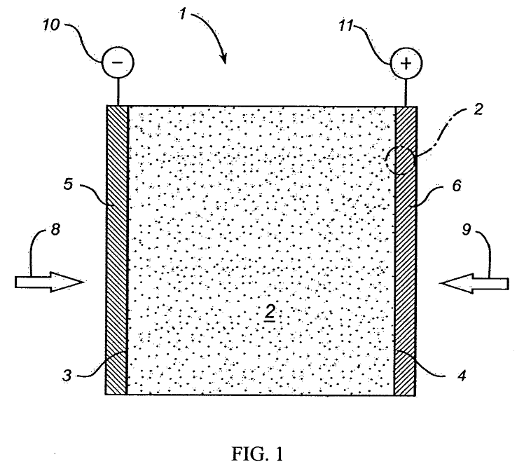

In general a polymer-electrolyte-membrane fuel cell (PEM FC) 1, is a power generation system for producing direct electrical current by an electrochemical reaction between hydrogen and oxygen, and the basic structure thereof is shown in FIG. 1. A PEM FC assembly 1, consists of a solid polymer electrolyte membrane 2, having a first surface 3, and a second surface 4, wherein the anode 5, is supported on the first surface 3, of the membrane 2, and the cathode 6, is supported on the second surface 4, of the membrane 2 (FIG. 1). The anode and cathode are both known in the art as electrodes. A polymer electrolyte membrane 2, is 50 to 200 μm thick and is formed of a solid polymer electrolyte. In the PEM fuel cell, the anode 5 and the cathode 6 both have a backing layer (not shown) for supplying fuel gases and a catalyst layer where the oxidation/reduction reactions of gaseous fuels take place.

The oxidation/reduction reactions that take place in a PEM FC are represented by equations (A) and (B) (below). The reaction starts with the introduction of hydrogen fuel 8, to the anode 5, of the fuel cell 1, while oxygen-containing gas 9, is introduced to the cathode 6, of the fuel cell 1. The hydrogen fuel 8, reacts with the catalyst on the anode 5, to form protons and electrons as represented in equation (A). The protons formed migrate through the membrane 2, to the cathode 6. The electrons formed move through an external circuit to the cathode 6. At the cathode, the oxygen molecules in the fuel dissociate on the surface of the catalyst containing fuel to form atomic oxygen, which then reacts with the protons, and electrons to form water as represented in equation (B). The fuel cell 1, also has a connection to the anode 10, and a connection to the cathode 11, that are both either connected to an external circuit or to other fuel cells to allow removal of the current generated by the fuel cell 1.

H₂→2H⁺+2e⁻ (A)

½O₂+2H⁺+2e⁻→H₂O (B)

The catalyst layer in a PEM fuel cell is formed on a backing layer in the gas diffusion electrode of the PEM fuel cell. The backing layer is generally formed from a carbon cloth or a carbon paper and its surface can be treated with polytetrafluorethylene (PTFE) so that reactant gases and water transferred to the PEM and generated from the above reaction can easily penetrate therethrough.

### II. M_{y}M′_{y′}X_{z}X′_{z′} Complex

The catalyst contains metals, M and M′, selected from the Group VIB, VIIB, and VIII metals. M is preferably manganese, iron, cobalt, nickel, copper, molybdenum, ruthenium, rhodium, palladium, rhenium, osmium, iridium, platinum, or a mixture thereof. M′ is preferably molybdenum, tungsten, cobalt, nickel or mixture thereof. M and M′ have the same oxidation states which may be +1, +2, +3, +4, +5, or +6 depending on the specific M or M′. X is sulfur and X′ is selenium or a carbon containing compound. Y ranges from 0.1 to 3 and Y′ is between 0 and 1.

The catalyst of the form M_{y}M′_{y′}X_{z}X′_{z′} is formed in a reaction that may be run neat or in a nonaqueous solvent, such as the reactions and conditions described in U.S. Pat. No. 4,288,422, herein incorporated by reference. The reaction proceeds spontaneously upon mixing at a low temperature, below 400° C., and atmospheric pressure. The products may be isolated by filtration and washing using excess solvent (when a solvent is used) or by pumping off the co-produced anion salt if it is volatile. This low temperature preparation produces a catalyst with remarkably different characteristics from catalyst prepared at above 400° C., having different surface areas, particle size, and crystallinity.

The catalyst comprises crystalline, poorly crystalline, or amorphous forms. More particulary the catalyst comprises finely divided small composite particles which are non-crystalline or are partially crystalline. The particles are about 5×10 nm or less and have a particle size of 100 nm, 75 nm, 50 nm or 25 nm. The composite particles are 1000 nm or less, the individual particles that make up the composite particles are 100 nm or less and preferably less than about 10 nm.

### III. Fuels

A fuel cell requires both a source of hydrogen and a source of oxygen for operation. These fuels may be supplied in a variety of forms.

The hydrogen fuel can be supplied to the fuel cell in the form of substantially pure hydrogen or as a hydrogen-containing reformate. When a reformate is used, hydrogen fuel is produced within the fuel cell by converting a hydrocarbon-based fuel to hydrogen. Some examples of hydrogen-containing reformates are the product of the reformation of methanol and water or natural gas or of other liquid fuels. The “water-gas shift” catalytic process is known in the art and is used to produce hydrogen containing steam that can be used to fuel the PEM fuel cell (U.S. Pat. No. 6,350,297). In the present invention, the hydrocarbon-based fuel or hydrogen fuel may be less pure than is required in other fuel cells to reduce poisoning the catalyst. Although it is preferred to use a hydrogen-containing reformate with minimal CO and S contamination, the catalyst of the current invention will remain active for a longer period, than the standard catalyst, under conditions having these poisons.

The oxygen can be provided as substantially pure oxygen or the oxygen can be supplied from air at ambient or elevated pressure. Both hydrogen and oxygen gases are preferably humidified before use in the fuel cell (U.S. Pat. No. 6,350,297).

### IV. PEM Fuel Cell Membrane

The electrolyte in a PEM fuel cell is a solid proton-conducting polymer membrane. The electrolyte is maintained in a hydrated form during operation of the fuel cell to prevent loss of ionic conduction through the electrolyte. This generaly limits the operating temperature of the PEM typically to between 70° C. and 120° C., depending on the operating pressure.

The membrane comprises a suitable polymer or combination of polymers well known in the art. Perfluorosulfonic acid polymers are often used. Examples of polymers that can be used are described in U.S. Pat. Nos. 5,272,017 and 3,134,697 as well as in other patents and non-patent literature cited herein. Nonlimiting examples of proton conductive membranes used in the art include NAFION™, a perfluorinated sulfonic acid polymer from the E. I. Dupont De Nemours and Company and Gore Select™ from the Gore Company. The membrane is hydrated or saturated with water molecules to promote ion formation and transport. The membrane is hydrated by any suitable means, and is preferably hydrated by boiling in water before installation in the fuel cell.

### V. Catalytic Support

Catalysts for fuel cells are often supported on a conductive high surface area matrix material. High surface areas, a high surface density of anchoring surface, and often porosity are important characteristics of good catalytic support materials. The material is conductive and finely divided to increase the surface area. Material contemplated includes carbon black, graphitized carbon black, graphite, activated carbon, zeolite, mesoporous zirconia, carbon nanotubes, acetylene black, carbon nanohoms, ceramic foams, or a mixture of two or more support materials.

Carbon support is a common fuel cell catalyst support and typically has a surface area of about 10-50 m²/g. Carbon black, acetylene black, and graphite are all carbonacious support with differing particle size, physical structure, surface area, and percentage of carbon. Carbon black is available, for example, from the Cabot Company of Boston, Mass. Graphite is ground to a predetermined mesh size, such as 44 μm, and has a low surface density of available anchoring sites available for binding to the catalyst because many of the “edges” of the carbon are not available for attachment to the catalyst. Acetylene black, which is produced from incomplete combustion of or thermal decomposition of acetylene, has a particle size of 40-50 μm. Carbon black's particle size ranges from 8-500 μm. Carbon black and other carbonaceous materials have different surface areas/unit volume; with the surface area/unit volume of substances increasing as the particle size decreases.

The catalyst support material may comprise a conductive zeolite support such as the support described in U.S. Pat. Nos. 6,117,581 and 6,350,297. This support material has a greater surface area (100 to 400 m²/g) and a greater density of available anchoring sites for the catalyst as it contains hydrophylic surface acidic protonic entities. Therefore, the dispersion of the metal catalyst on the surface is increased relative to the standard carbon support providing for catalytic activity with lower concentrations of the metal catalyst. The use of zeolite catalyst support material can result in a lowering of resistance and power loss (ohmic) over a carbon-containing electrode. High gas permeability is also found with this zeolite support material due to an array of channels, which increase the amount of power that can be drawn from the electrode over the hydrophilic zeolite surface.

Mesoporous zirconia is another support that may be used with the catalyst of the current invention. These particles can be formed having large spherical particles (about 10 μm), which provide uniform packing, high surface area (130 m²/g), and nanoscale porosity (2-10 nm). This support has a high internal surface area to maximize the amount of accessible catalyst and have the additional known property of being able to enhance the activity of supported catalysts. Mesoporous zirconia also has a high thermal stablility and can be formed using aqueous or non-aqueous processes (U.S. Pat. No. 5,645,891).

Carbon nanotubes (or carbon fibrils) are molecular scale seamless tubes formed of pure carbon. Single-walled carbon nanotubes generally have an external diameter of from about 0.7 nm to about 5 nm. Multi-walled carbon nanotubes and subsequently as single-walled carbon nanotubes were found in the presence of transition metal catalysts. Generally, single-walled carbon nanotubes have fewer defects, are stronger, have a higher conductivity and are therefor preferred over multi-walled carbon nanotubes. Carbon nanotube are produced by the laser ablation of carbon (Thess et al., 1996), the electric arc discharge of graphite rod (Journet et al., 1997), the chemical vapor deposition of hydrocarbons (Ivanov et al., 1994; Li et al., 1996), and by contacting a metal catalyst and a carbon-containing gas at a sufficient temperature in a reactor cell (U.S. Pat. No. 6,333,061).

Carbon nanohorns are a particular form of carbon nanotubes that have a conical end. They have average cone angles of 20° with a typical diameter of about 2 nm and lengths ranging from 30-50 nm. The nanohorns occur as spherical aggregates with a diameter of about 80 nm. This material has been found to adsorb liquids (ethanol) effectively. This aggregate has a large surface area and has an easily accessible interior surface for catalyst adhesion and catalyst-reactant interactions. This support can increase the efficiency of the PEM (Nisha et al., 2000). Fuel cells with the carbon nanohoms have been shown to generate about 20% more electric power than conventional fuel cells with activated-carbon electrodes. Carbon nanohoms can be prepared by laser ablation and have been synthesized in bulk (Iijima et al., 1999).

Ceramic foams are also contemplated for use as a support for the catalyst of the current invention. One high porosity reticulated foam material that may be used as the catalytic support of the current invention is formed using a reticulated/interconnected web precursor to which a metal or ceramic coating is applied. The precursor is removed through a thermal process and the coating is sintered, leaving behind a rigid structure. The metal or ceramic foam material is extremely lightweight and has a very high surface area when compared to that of the same sized non-porous shape (U.S. Pat. No. 6,379,833). A ceramic foam may also be formed with a perovskite-type powder as describe in U.S. Pat. No. 6,352,955. This open cell foam is formed by methods known in the art by mixing with carbon powder and heating in the presence of a sufficiently oxygen-containing atmosphere such that the carbon support is removed and a solid ceramic foam with open, interconnected cells is formed.

For porous support materials, it is prefered that the pore size 100 nm or less and the porosity should be 30-40%.

### VI. Preparation of the Supported Catalyst

In one preparation method, the catalyst may be deposited on the support material by suspending the support in water and adjusting the pH to appropiate acidity. The metal catalyst is added to this solution. A reducing agent is then added to deposit the catalyst, then the supported catalyst is filtered, washed and dried.

In a second preparation, the support material is created at the same time the catalyst is adhered to the support. If the support is prepared by ablation, the catalyst may also be ablated to form a supported catalyst structure in one simple step.

In another preparation, the catalyst is deposited on the support material and then suspended in a liquid carrier to form an ink. The ink may be hot-pressed onto the PEM membrane to form the electrodes.

In one embodiment the particulate carbon is and zeolite are closely (intimately) mixed and then the catalytic particles are uniformly dispersed the mixture. The catalyst containing mixture can then be mixed in a liquid to form an ink. Alternatively, the carbon and the zeolite can be added separately in the proper proportions to a liquid carrier and mixed as a suspension to form the ink (U.S. Pat. No. 6,350,297).

The ink is then hot-pressed onto the first and second surfaces respectively, of the membrane in any suitable manner to form the fuel cell. The ink can be hot-pressed directly onto the first and second surface of the membrane. In another embodiment a coat of ink is applied to a gas permeable conductive paper, such as carbon paper, which is then hot-pressed onto the first and/or second surfaces of and of the membrane. The ink can also be coated onto a carrier paper, such as Teflon paper, which can then be hot-pressed onto the first and/or second surfaces of the membrane after which the Teflon paper can be removed from the fuel cell (U.S. Pat. No. 6,350,297).

Furthermore, the ink(s) and therefore electrodes, in additon to the catalyst particulate, the carbon, and conductive zeolite or nanotubes, can include a suitable binder material or a proton conducting material as is known in the art.

Any of the inks previouly described can be transferred to the support by a screen printing process or by a spray coating process as known in the art.

### VII. Definitions

As used herein the term “crystalline” is define as of pertaining to resembling, or composed of crystals. As used herein the term “crystal” is defined as a homogeneous solid made up of an element, chemical compound or isomorphous mixture throughout in which the atoms or molecules are arranged in a regular repeating pattern; or a material or synthetic piezoelectric or semiconductor material whose atoms are arranged with some degree of geometric regularity. As used herein the term amorphous pertains to a solid which is non-crystalline having neither definite form nor structure.

As used herein, the phrase “resistance to poisoning” for a catalyst is defined as the ability of a catalyst to fuction when exposed to CO and or Sulfur over a period of time. Furthermore, for a catalyst of the current invention the ability to fuction when exposed to CO and/or Sulfur is greater when compared to a platinum catalyst. The difference in efficiency after substantial exposure should be at least a 5%, 10%, and more preferably at least a 20% difference. As used herein, the phrase “carbon containing compound” is defined as a compound containg at least one carbon molecule. Preferably, carbon containing compounds will be any allotrope of carbon, buckminsterfullerene, derivatized buckminsterfullerene, carbon nanotubes, carbon nanorods, carbon black, graphite, partially graphitized carbon, acetylene black, or carbon nanohoms. As used herein the specification, “a” or “an” may mean one or more. As used herein in the claim(s), when used in conjunction with the word “comprising,” the words “a” or “an” may mean one or more than one. As used herein “another” may mean at least a second or more.

### VIII. EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### a. Synthesis of Catalyst

The general synthetic methods that can be used to obtain the catalysts of the present invention are found in Chianelli (1978); Passaratti, J. D. (1981); or U.S. Pat. No. 4,288,422.

### b. Synthesis of RuS₂

The catalyst RuS₂ was prepared by heating (NH₄)₃RuCl₃ in H₂/H₂S in an atomosphere of H₂/10% H₂S for two hours at 350° C. according to the following reaction:

(NH₄)₃RuCl₃+2H₂S →RuS₂+3NH₃↑+3HCL↑+2H₂ (C)

The catalyst was characterized by x-ray diffraction and infrared spectroscopy and had a BET surface area of 58 m²/g.

### C. Electrochemical Cell for Testing Electrodes

The electrodes were tested in an electrochemical cell using a three electrode configuration as shown in FIG. 1. The gas diffusion electrode was mounted into a Teflon holder containing a gold mesh as a current collector. The working electrode area is 7.84 cm². It was exposed to the gas on the non active side (carbon paper only) and the solution on the active side. A platinum sheet electrode was used as counter electrode fitted into the solution compartment. The distance between working electrode and counter electrode was 2 cm. A saturated calomel reference electrode (SCE, E=+0.242 V vs NHE) was external to the cell and connected to the solution compartment through a Luggin capillary whose tip was placed close to the working electrode surface. A 0.1 M H₂SO₄ solution was used as electrolyte and was recirculated through the solution compartment of the test cell at 300 cm³ min⁻¹. Nitrogen gas was purged into the electrolyte pipeline system. Hydrogen and carbon monoxide were passed through a humidifier at ambient temperature and then to the experimental cell. The H₂ volumetric flow rate was 30 cm3 min⁻¹ and the CO flow rate was 0.03 cm³ min⁻¹ or 0.3 cm³ min⁻¹, to obtain a mixture of 0.1% and 1% CO in H₂, respectively. The electrochemical cell was connected to a Biologic MacPile multichannel microprocessor potentiostat/galvanostat controlled by computer. The measurements were made using the potentiostat at 0.25 mVs⁻¹, the voltage window was changed according to the current limitations. Pure hydrogen was supplied during the first cycle, and subsequently 0.1% and 1.0% CO/H₂ mixtures were used

### d. GDE2

A gas diffusion electrode was made by the following procedure. A substrate of carbon paper (4×4 cm²) with diffusion layer was dried at 70° C. for 1 h. A catalyst ink was prepared from RuS₂ by mixing the catalyst with 5 wt % Nafion solution and glycerol in the ratio 1/0.6/2.94 by dry weight and using ethanol as solvent (catalyst:ethanol=1:30). The mixture was stirred and then mixed in an ultrasonic bath for 30 min. The catalyst ink was then sprayed onto the weighed substrate with an airbrush. The electrode was then dried for 30 min at 70° C. and cooled to room temperature in a desiccator. The loading was 0.44 mg/cm² as determined by the weight of the final electrode.

### e. GDE8

A gas diffusion electrode was made by the following procedure. A substrate of carbon cloth (4×4 cm²) with diffusion layer was dried at 80° C. for 1 h. A catalyst ink was prepared from RuS₂ by mixing the catalyst and carbon powder (Vulcan XC-72R) mixture (80 wt % catalyst) with 5 wt % Nafion solution and glycerol in the ratio 1/0.6/2.5 by dry weight and using ethanol as solvent (catalyst/C:ethanol=1:20). The mixture was stirred and then mixed in an ultrasonic bath for 30 min. The catalyst ink was then sprayed onto the weighed substrate with an airbrush. The electrode was then dried for 30 min at 80° C. and cooled to room temperature in a desiccator. The process was repeated 8 times to obtain a loading of 2.64 mg/cm² as determined by the weight of the final electrode.

### f. Pt/C at 10%

The comparison electrode was a commercial electrode from E-TEK^{SM}, comprising 10% Pt/C with Pt loading of 0.35 mg/cm² on carbon paper (4×4 cm²).

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain compositions which are chemically related may be substituted for the compostions described herein while the same or similar results would be achieved. All such similar substitutes and modifications apparent to those skilled in the art are deemed to be within the spirit, scope and concept of the invention as defined by the appended claims.

### IX. References

The following references, to the extent that they provide exemplary procedural or other details supplementary to those set forth herein, are specifically incorporated herein by reference.

Alonso et al., Catalysis Letters, 52:55-61, 1998b.

Alonso et al., Catalysis Today, 43:117-122, 1998a.

Brito et al., Thermochimica Acta, 256:325-338, 1995.

Chianelli, R. R.; Dines, M. B. “Low Temperature Solution Preparation of Group 4b, 5b, and 6b, Transition Metal Sulfides”, Inorg. Chem. 17, 2758, 1978.

E.G. & G. Services—Parsen Inc., SAIC Fuel Cells: A Handbook—5th Ed. (Fuel Cell Information Series) 5th ed. Business/Technology Books; 2000.

Hooger, G. (ed.) Fuel Cell Technology Handbook CRC Press; 2002.

Larminie, J.; Dicks, A. Fuel Cell Systems Explained John Wiley & Sons; 2000.

Lide, D. R. Handbook of Chemistry and Physics 83rd Ed., CRC Press, 2002.

Othmer, K. Encyclopedia of Chemical Technology vol. 15, 4th Ed., pp. 198-202, 1995.

Parker, S. P. Ed. McGraw-Hill Dictionary of Scientific and Technical Terms, 5th ed., 1994.

Passaratti et al., “Preparation and Properties of Poorly Crystalline CoS2 and RuS2”, J. Catal. 20, 2631, 1981.

Reeve et al., J. Electrochem. Soc., Vol. 145, No. 10, October 1998.

U.S. Pat. No. 4,243,554

U.S. Pat. No. 4,508,847

U.S. Pat. No. 4,431,747

U.S. Pat. No. 4,528,089

U.S. Pat. No. 4,650,563

U.S. Pat. No. 4,581,125

U.S. Pat. No. 4,514,517

U.S. Pat. No. 4,839,326

U.S. Pat. No. 4,820,677

U.S. Pat. No. 4,279,737

U.S. Pat. No. 6,156,693

U.S. Pat. No. 6,350,297

U.S. Pat. No. 6,232,264

U.S. Pat. No. 6,117,581

U.S. Pat. No. 6,379,834

U.S. Pat. No. 4,288,422

What is claimed is:

1. An electrode comprising a catalyst that is resistant to poisoning by carbon monoxide and sulfur, said catalyst having the formula:
M_{Y}M′_{Y′}X_{Z}X′_{z′};
wherein M is iron, cobalt, nickel, copper, molybdenum, ruthenium, rhodium, palladium, rhenium, osmium, iridium, platinum, or mixture thereof;
M′ is molybdenum, tungsten, cobalt, nickel or mixture thereof;
X is S;
X′ is Se or a carbon containing compound; or ₜCₜ;
(Z+Z′)/(Y+Y′)>4/3;
Y is 0.1 to 3;
Y′ is 0 to 0.9;
Z is 0.1 to 5;
Z′ is 0 to 0.9;
0<t<1; and
a catalyst support material.

2. The electrode of claim 1, wherein M_{Y} is ruthenium; M′_{Y′} is cobalt; X_{Z} is sulfur; X′_{z′} is C or Se; Y is 0.1 to 3; Y′ is 0 to 0.9; Z is 0.1 to 5; Z′ is 0 to 0.9.

3. The electrode of claim 1, wherein M_{Y} is Ru; X is S; X′ is ₜCₜ; and Z is 2.

4. The electrode of claim 1, wherein M_{Y} is Mo; X is S; X′ is ₜCₜ; and Z is 2.

5. The electrode of claim 1, wherein M_{Y} is ruthenium; X is S; and Z is 1.9 to 2.5.

6. The electrode of claim 1, wherein said catalyst is in a crystalline, poorly crystalline, or amorphous form.

7. The electrode of claim 1, wherein said electrode is incorporated in an electrochemical device.

8. The electrode of claim 7, wherein said electrochemical device is a fuel cell, an electrolyser, or a sensor.

9. The electrode of claim 8, wherein said electrode is incorporated in a fuel cell.

10. The electrode of claim 1, wherein said catalyst support material comprises a mesoporous zirconia, or ceramic foam material.

11. The electrode of claim 1, wherein said catalyst support material comprises a carbon support material.

12. The electrode of claim 11, wherein said carbon support material comprises a carbon black, graphite, partially graphitized carbon, acetylene black, carbon nanotubes, acetylene black, or carbon nanohoms.

13. The electrode of claim 12, wherein said catalyst support material is carbon black.

14. The electrode of claim 11, wherein said carbon catalyst support material further comprises a zeolite.

15. The electrode of claim 11, wherein said carbon support material comprises carbon material mixed with zeolite material.

16. The electrode of claim 11, wherein said cabon support material comprises carbon particles being layered adjacent to zeolite particulate material.

17. The electrode support material of claim 1, wherein said support material further comprises a conductive material.

18. The electrode of claim 17, wherein said conductive material comprises a conductive particulate zeolite material.

19. The electrode of claim 17, wherein said conductive material comprises a conductive polymer.

20. The electrode of claim 19, wherein said conductive polymer is selected from the group consisting of polyacetylene, polypyrrole, polythiophene, polyaniline and mixtures thereof.

21. The electrode of claim 18, wherein said conductive particulate zeolite material comprises continuous channels containing conductive material within the channels.

22. The electrode of claim 21, wherein said conductive material contains alkali metal cations.

23. A fuel cell comprising a catalyst that is resistant to poisoning by carbon monoxide and sulfur, said catalyst having the formula:
M_{Y}M′_{Y′}X_{Z}X′_{z′};
wherein M is iron, cobalt, nickel, copper, molybdenum, ruthenium, rhodium, palladium, rhenium, osmium, iridium, platinum, or mixture thereof;
M′ is molybdenum, tungsten, cobalt, nickel or mixture thereof;
X is S;
X′ is Se or a carbon containing compound; or ₜCₜ;
(Z+Z′)/(Y+Y′)>4/3;
Y is 0.1 to 3;
Y′ is 0 to 0.9;
Z is 0.1 to 5;
Z′ is 0 to 0.9;
0<t<1; and
a catalyst support material.

24. The fuel cell of claim 23, wherein said fuel cell is a polymer-electrolyte-membrane fuel cell.

25. The fuel cell of claim 23, wherein said fuel cell is a phosphoric acid fuel cell.

26. The fuel cell of claim 23, wherein said fuel cell is a regenerative fuel cell.
